(19) United States
(12) Patent Application Publication
(10) Pub. No.: US 2026/0222676 A1
(43) Pub. Date: Jul. 30, 2026

(54) IMAGING DEVICE

(71) Applicant: CANON KABUSHIKI KAISHA, Tokyo (JP)

(72) Inventor: KOJI OGAKI, Kanagawa (JP)

(21) Appl. No.: 19/424,431

(22) Filed: Dec. 18, 2025

(30) Foreign Application Priority Data
Jan. 28, 2025 (JP) 2025-012024

(51) Int. Cl. H04N 23/63; G06F 3/04845

(52) U.S. Cl. CPC H04N 23/635; G06F 3/04845

(57) ABSTRACT

An imaging device sets a part of a captured image captured by an image sensor as a crop area, performs control to display the captured image on a display in an aspect in which the crop area is identifiable, acquires a partial image, which is an image of the crop area, from the captured image, executes rotation processing of rotating the partial image, and performs control to rotate the acquired partial image by the rotation processing and output the partial image after the rotation from an output interface to an outside, wherein control is performed so as to display the captured image on the display in an aspect in which a direction and a magnitude of the rotation by the rotation processing are further identifiable.

### BACKGROUND

### Field of the Technology

The present disclosure relates to an imaging device, and more particularly, to a technology for displaying a captured image captured by the imaging device on an external display device.

### Description of the Related Art

In recent years, with the spread of smartphones and the like, vertically long display devices (for example, a display device in which the aspect ratio (horizontal width: vertical width) of the display surface is 9:16) have increased in addition to the conventional horizontally long display devices (for example, a display device in which the aspect ratio of the display surface is 16:9). Then, in order to obtain a vertically long image from a horizontally long image, a technique of cutting out a part of the horizontally long image and a technique of displaying an on-screen display (OSD) of a frame indicating an area to be cut out have been proposed. Japanese Patent Laid-Open No. 2024-85697 discloses a technique of displaying a marker in association with a frame indicating an area of an image output from a terminal that has received a tally signal among a plurality of frames.

There is a need to install and use a horizontally long display device in a vertical orientation. The vertical orientation is one of the orientations of the display device, and the horizontal direction of the display device is substantially parallel to the vertical direction. However, when a horizontally long display device is installed and used in a vertical orientation, a vertically long image may not be suitably displayed.

### SUMMARY

The present disclosure provides a technique capable of suitably displaying a vertically long image when a horizontally long display device is installed and used in a vertical orientation.

An imaging device according to the present disclosure includes an image sensor, an output interface configured to output an image to an outside, a processor, and a memory storing a program which, when executed by the processor, causes the imaging device to execute setting processing of setting a part of a captured image captured by the image sensor as a crop area, execute display control processing of performing control to display the captured image on a display in an aspect in which the crop area is identifiable, execute acquisition processing of acquiring a partial image, which is an image of the crop area, from the captured image, execute rotation processing of rotating the partial image, and execute control processing of performing control to rotate, by the rotation processing, the partial image acquired by the acquisition processing and output the partial image after the rotation from the output interface, wherein in the display control processing, control is performed so as to display the captured image on the display in an aspect in which a direction and a magnitude of the rotation by the rotation processing are further identifiable.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an imaging device.

FIG. 2 is a flowchart of photographing mode processing.

FIG. 3 is an explanatory diagram of a problem to be solved.

FIG. 4 is a flowchart of display processing.

FIG. 5 is a schematic diagram illustrating an operation of the imaging device.

FIG. 6 is an explanatory diagram of rotation processing.

FIGS. 7A to 7D are explanatory diagrams of lower items.

### DESCRIPTION OF THE EMBODIMENTS

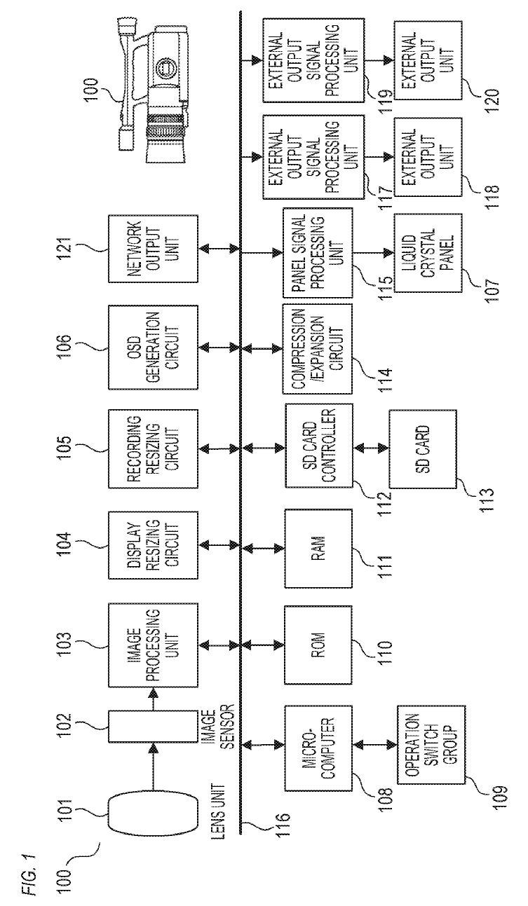

Hereinafter, an embodiment of the present disclosure will be described. FIG. 1 is a block diagram illustrating a configuration of an imaging device 100.

A lens unit 101 includes a fixed lens group, a variable magnification lens group, a diaphragm, and a correction lens group for condensing light, and corrects an image formation position or adjusts a focus by controlling the components of the lens unit 101. The lens unit 101 forms an object image on an image formation surface of an image sensor 102. The lens unit 101 is detachable from the imaging device 100.

The image sensor 102 is an imaging unit that converts light into electric charge and generates an imaging signal. The generated imaging signal is output to an image processing unit 103. The image sensor 102 is an imaging element such as a CCD image sensor or a CMOS image sensor. Note that, a so-called dual-pixel type imaging element may be used in which each of all the pixels on the imaging surface is constituted by a pair of light receiving elements, and a pair of optical images formed by microlenses in each pixel can be converted into an electrical signal by a pair of light receiving elements.

The image processing unit 103 converts the imaging signal input from the image sensor 102 into RAW data (RAW image). Thereafter, the image processing unit 103 performs RAW development processing including interpolation processing and image quality adjustment processing on the RAW data to generate image data in a YUV format corresponding to the RAW data, and stores the generated image data in a RAM 111.

A display resizing circuit 104 generates display image data by performing resizing processing or the like on the YUV format image data stored in the RAM 111, and stores the generated display image data in the RAM 111. When generating the display image data, the display resizing circuit 104 also performs crop processing and rotation processing described later as necessary.

A recording resizing circuit 105 generates recording image data by performing resizing processing or the like on the YUV format image data stored in the RAM 111, and stores the generated recording image data in the RAM 111.

An on-screen display (OSD) generation circuit 106 generates OSD data representing graphics such as various setting menus, titles, times, icons, and warning words, and stores the generated OSD data in the RAM 111. The stored OSD data can be combined with the display image data stored in the RAM 111. The combined image data obtained by combining the OSD data with the display image data is displayed on a liquid crystal panel 107 or output from an external output unit 118, 120 or a network output unit 121 to the outside. The stored OSD data may be combined with the recording image data stored in the RAM 111 and recorded in an SD card 113. An item to be described later indicating rotation by the rotation processing is generated by an OSD generation circuit 106.

The liquid crystal panel 107 is a display unit (display device) that displays an image (video) based on the image data output from a panel signal processing unit 115.

A microcomputer 108 controls the entire imaging device 100.

An operation switch group 109 includes a plurality of operation members that receive operations from a user. The plurality of operation members may include physical buttons or a touch panel.

A ROM 110 is a flash ROM, and the ROM 110 stores various data including a program executed by the microcomputer 108. In addition, a partial area of the ROM 110 is used to store (back up) various pieces of information such as system state information.

The RAM 111 is a volatile memory used as a work memory. For example, the RAM 111 is used as a work memory by the microcomputer 108, the image processing unit 103, a compression/expansion circuit 114, and the like.

An SD card controller 112 records image data generated by the compression/expansion circuit 114 and stored in the RAM 111 in the SD card 113 according to a format compatible with a computer, such as a FAT file system. The SD card 113 is a recording medium detachable from the imaging device 100, and can be mounted on an electronic device (for example, a personal computer) other than the imaging device 100. The imaging device 100 may be able to record image data on a non-detachable recording medium (a recording medium built in the imaging device 100).

The compression/expansion circuit 114 compresses (encodes) the image data stored in the RAM 111 and stores the image data in the RAM 111, and expands (decodes) the image data read from the SD card 113. For example, the compression/expansion circuit 114 generates moving image data by performing MPEG compression on the image data stored in the RAM 111, and stores the moving image data in the RAM 111.

The panel signal processing unit 115 reads the display image data from the RAM 111, and outputs the read display image data to the liquid crystal panel 107. The panel signal processing unit 115 can also read OSD data from the RAM 111, generate combined image data, and output the combined image data to the liquid crystal panel 107. When outputting the image data to the liquid crystal panel 107, the panel signal processing unit 115 converts a signal format of the image data into a signal format displayable by the liquid crystal panel 107.

A bus 116 communicably connects a plurality of components of the imaging device 100 to each other.

An external output signal processing unit 117 reads the display image data from the RAM 111, and outputs the read display image data to the external output unit 118. The external output signal processing unit 117 can also read OSD data from the RAM 111, generate combined image data, and output the combined image data to the external output unit 118. When outputting the image data to the external output unit 118, the external output signal processing unit 117 converts a signal format of the image data into a signal format that can be output by the external output unit 118.

The external output unit 118 has an external output terminal such as an SDI terminal or an HDMI (registered trademark) terminal, and outputs the image data output from the external output signal processing unit 117 to the outside.

An external output signal processing unit 119 reads the display image data from the RAM 111, and outputs the read display image data to the external output unit 120. The external output signal processing unit 119 can also read OSD data from the RAM 111, generate combined image data, and output the combined image data to the external output unit 120. When outputting the image data to the external output unit 120, the external output signal processing unit 119 converts a signal format of the image data into a signal format that can be output by the external output unit 120.

The external output unit 120 has an external output terminal such as an SDI terminal or an HDMI (registered trademark) terminal, and outputs the image data output from the external output signal processing unit 119 to the outside.

The network output unit 121 reads the display image data from the RAM 111 and outputs the read display image data to an external network. The network output unit 121 can also read OSD data from the RAM 111, generate combined image data, and output the combined image data to the external network. The output image data can be browsed through a general web browser. The network output unit 121 has a network terminal such as an RJ45 connector, and outputs an image to the network via a LAN cable connected to the network terminal. Alternatively, an image may be output not by wired output but by a wireless LAN such as Wi-Fi (registered trademark).

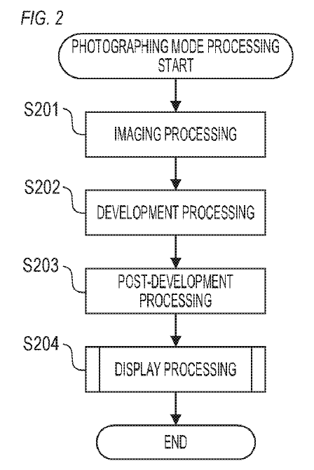

FIG. 2 is a flowchart of photographing mode processing performed by the imaging device 100. The photographing mode processing of FIG. 2 is realized by the microcomputer 108 developing a program stored in the ROM 110 in the RAM 111 and executing the program. For example, when the imaging device 100 is activated in the photographing mode or transitions from another mode to the photographing mode, the photographing mode processing is started. In the photographing mode, the photographing mode processing is repeatedly performed at the frame rate of imaging by the image sensor 102.

In S201, the microcomputer 108 performs control to acquire RAW data (RAW image). The microcomputer 108 controls the image sensor 102 to output an imaging signal (sensor data) from the image sensor 102 to the image processing unit 103. Then, the microcomputer 108 converts the imaging signal into RAW data by gamma processing or the like, and controls the image processing unit 103 to store the RAW data in the RAM 111.

In S202, the microcomputer 108 controls the image processing unit 103 to convert the RAW data acquired in step S201 into development data (developed image) by development processing, and store the development data in the RAM 111.

In S203, the microcomputer 108 controls the image processing unit 103 to convert the development data acquired in S202 into main image data (main image) by predetermined correction processing (post-processing of development processing) and store the main image data in the RAM 111.

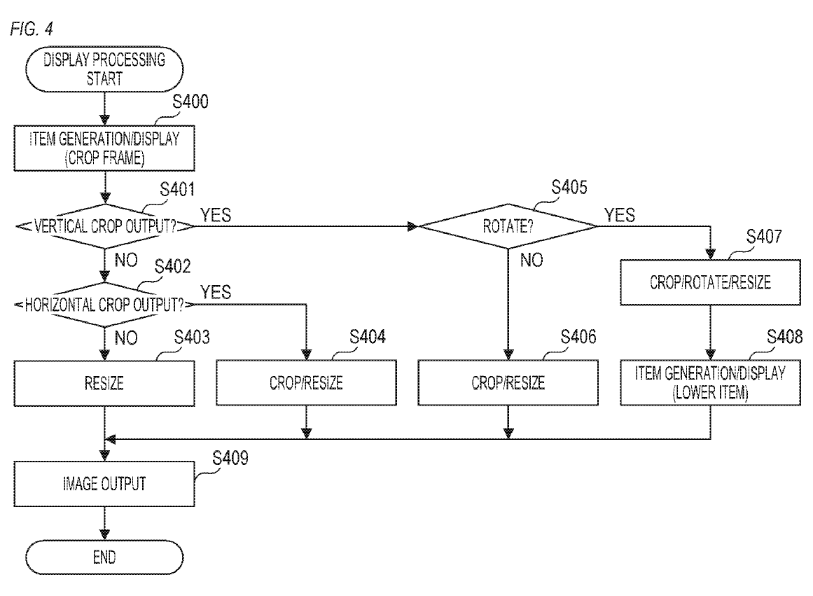

In S204, the microcomputer 108 performs display processing of outputting and displaying an image (video) based on the captured image captured by the image sensor 102. Details of the display processing will be described later with reference to FIG. 4.

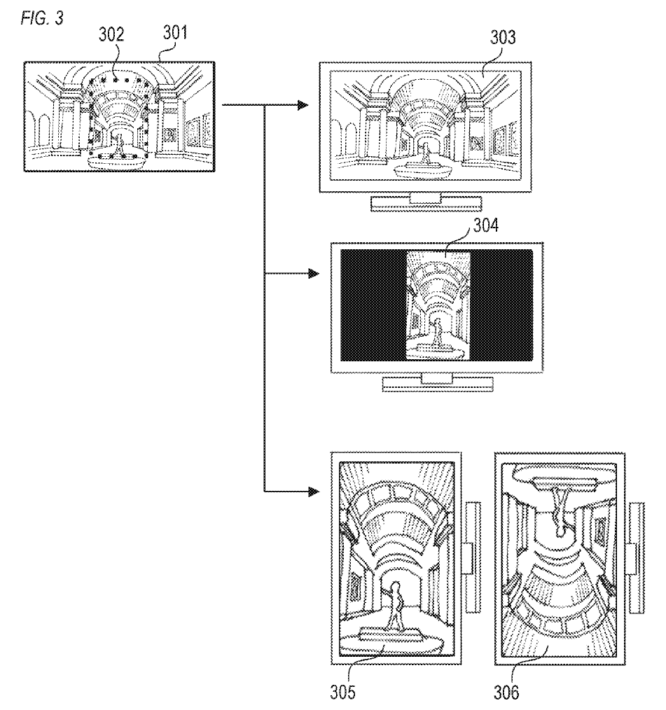

An example of the problem to be solved in the present embodiment will be described with reference to FIG. 3. An image 301 in FIG. 3 is an example of the main image obtained in S203 in FIG. 2. The main image 301 may be interpreted as a captured image captured by the image sensor 102. The aspect ratio of the main image 301 is not particularly limited, but is a horizontally long aspect ratio (for example, horizontal width (length in the horizontal direction): vertical width (length in the vertical direction) =16:9) in FIG. 3.

When the horizontally long display device (for example, a display device in which the aspect ratio of the display surface is 16:9.) is installed at the normal position and used, the main image 301 can be suitably displayed in the correct orientation as in the display 303. The normal position is one of the orientations of the display device, and the upward direction of the display device is substantially equal to the zenith direction.

With the spread of smartphones and the like, there is an increasing need to capture a vertically long image simultaneously with the horizontally long main image 301. For example, there is a need to capture an image for a smartphone at an aspect ratio of 9:16 while capturing an image for television broadcasting at an aspect ratio of 16:9. For this reason, a case of displaying a vertically long partial image 302 which is an image of a partial area of the main image 301 will be considered. The aspect ratio of the partial image 302 is, for example, 9:16.

In this case, when the horizontally long display device is installed and used at the normal position, the video is not displayed on most of the display surface as in the display 304, and the partial image 302 is displayed only on a part of the display surface. When a horizontally long display device is installed in a vertical orientation and the partial image 302 is rotated by approximately 90 degrees or approximately 270 degrees with a direction perpendicular to the partial image 302 as an axis, the partial image 302 can be displayed on the entire display surface (most part of the display surface). The vertical orientation is one of the orientations of the display device, is an orientation in which the horizontal direction of the display device is substantially parallel to the vertical direction, and is an orientation rotated by approximately 90 degrees or approximately 270 degrees with the direction perpendicular to the display surface from the normal position as an axis.

However, unless the rotation corresponding to the rotation of the display device is performed as the rotation of the partial image 302, the partial image 302 cannot be suitably displayed. Here, a case where the orientation of the display device is vertical (vertical orientation rotated 270 degrees to the right (clockwise) from the normal position) rotated 90 degrees to the left (counterclockwise) from the normal position will be considered. In this case, if the image of the partial image 302 is rotated 90 degrees to the right (270 degrees to the left), the partial image 302 can be displayed in the correct orientation as in the display 305. However, when the image of the partial image 302 is rotated 270 degrees to the right (90 degrees to the left), the partial image 302 is displayed upside down as in the display 306. The user cannot grasp whether the rotation of the partial image 302 and the rotation of the display device are performed in a correct correspondence relationship until viewing the display 305 or the display 306.

Therefore, in the present embodiment, GUI components are displayed on the main image (captured image) so that the direction and magnitude of the rotation of the vertically long image (partial image) are identifiable. Consequently, the user can easily grasp the rotation of the horizontally long display device corresponding to the rotation of the vertically long image, and the vertically long image can suitably be displayed when the horizontally long display device is installed and used in the vertical orientation.

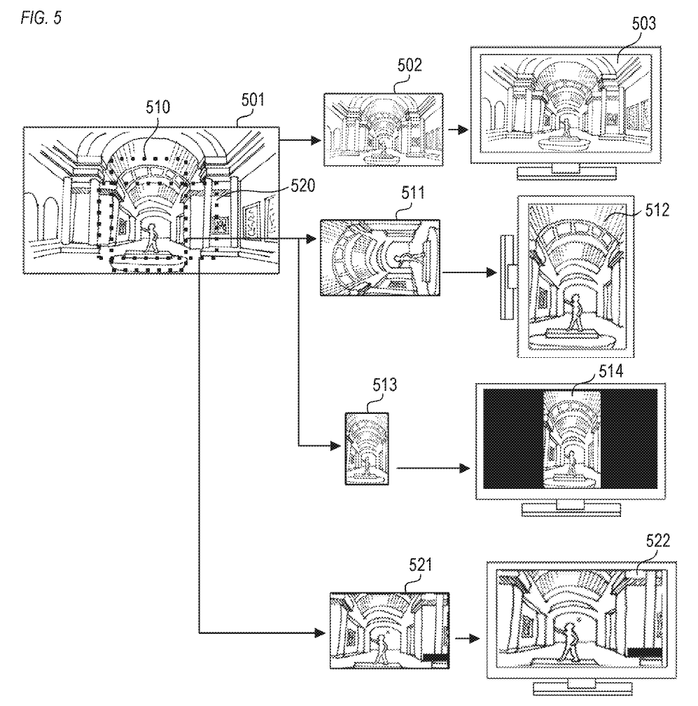

FIG. 4 is a flowchart of the display processing performed in S204 of FIG. 2, and FIG. 5 is a schematic diagram illustrating an example of the operation in the present embodiment. In the present embodiment, the main image is displayed on the liquid crystal panel 107. Then, an image subjected to processing such as resizing, cropping, and rotation is output to the external output unit 118, the external output unit 120, and the network output unit 121 according to the setting. The processing of FIG. 4 is individually performed on the components used for image output among the external output unit 118, the external output unit 120, and the network output unit 121.

In S400, the microcomputer 108 controls the OSD generation circuit 106 to generate an item (crop frame) indicating the set crop area. Then, the microcomputer 108 controls each unit of the imaging device 100 so that the generated crop frame is superimposed on the main image and displayed on the liquid crystal panel 107. When the crop area is not set, the main image is displayed on the liquid crystal panel 107 without generating an item indicating the crop area.

In S401, the microcomputer 108 determines whether or not to output the image of the vertical crop area. That is, it is determined whether the vertical crop area having a vertical length larger than the horizontal length is set as the area of the image to be externally output. When the image of the vertical crop area is output, the process proceeds to S405. Otherwise, the process proceeds to S402.

The microcomputer 108 can set a partial area of the main image as a crop area. For example, the microcomputer 108 sets an area specified by the user as a crop area. The processing of acquiring (cropping, extracting, cutting out) the image of the crop area from the main image is the crop processing. The position and size of the crop area are not particularly limited, and may be changeable by the user. The vertical crop area is a crop area in which a vertical width (length in the vertical direction) is longer than a horizontal width (length in the horizontal direction). The image in the vertical crop area is a partial image. The user may specify the crop area using the operation switch group 109 or an external device. In a case where an external device is used, a command according to specification from the user is received by the network output unit 121 (communication unit), a dedicated reception circuit, or the like. The microcomputer 108 may automatically set the crop area based on the captured image, the display device to be used, the output unit to be used, or the like.

An image 501 in FIG. 5 is a main image displayed on the liquid crystal panel 107, and the size of the main image 501 (the number of pixels in the horizontal direction × the number of pixels in the vertical direction) is 3840 × 2160 pixels. The area 510 is a crop area, and the size of the crop area 510 is 1080 × 1920 pixels. Therefore, the crop area 510 is a vertical crop area.

In S402, the microcomputer 108 determines whether or not to output the image of the horizontal crop area. That is, it is determined whether a horizontal crop area having a horizontal length larger than a vertical length is set as an area of an image to be externally output. When the image of the horizontal crop area is output, the process proceeds to S404, and when the image of the horizontal crop area is not output (when the entire main image is output), the process proceeds to S403. An area 520 in FIG. 5 is a crop area, and the size of the crop area 520 is 1920 × 1080 pixels. Therefore, the crop area 520 is a horizontal crop area.

Of the image in the vertical crop area, the image in the horizontal crop area, the entire main image, and the like, which image to output (display) may be individually set for each of the external output unit 118, the external output unit 120, and the network output unit 121. Which image to output may be automatically determined based on a display device to be used, an output unit, or the like. Which image to output may be specified by the user. Which image is to be output may be determined in advance for each of the external output unit 118, the external output unit 120, and the network output unit 121. The output image may be specified from the user using the operation switch group 109 or using an external device.

In S403, the microcomputer 108 performs resizing processing (size conversion) on the main image, and controls the display resizing circuit 104 to store the resized image in the RAM 111. In the present embodiment, the size of the image is determined in advance for each of the external output unit 118, the external output unit 120, and the network output unit 121. Then, in the resizing processing, the size of the main image is converted to a size corresponding to a component to be processed among the external output unit 118, the external output unit 120, and the network output unit 121. For example, when the size of the main image is 3840 × 2160 pixels and the size corresponding to the component to be processed is 1280 × 720 pixels, the size of the main image is converted from 3840 × 2160 pixels to 1280 × 720 pixels. The image 502 in FIG. 5 is an image obtained by the resizing processing on the main image 501. The size of the main image may be converted so as to match the size (resolution) of the display surface of the display device to be used. A method of the resizing processing is not particularly limited, and various methods such as a bicubic method and a bilinear method can be used for the resizing processing. A learned model by deep learning or the like may be used for the resizing processing.

In S404, the microcomputer 108 acquires (crops, extracts, cuts out) the image of the horizontal crop area from the main image, performs resizing processing on the acquired image, and controls the display resizing circuit 104 to store the image after the resizing processing in the RAM 111. Consider a case where the size of the main image is 3840 × 2160 pixels, the size corresponding to the component to be processed is 1280 × 720 pixels, and the size of the horizontal crop area is 1920 × 1080 pixels. In this case, the size of the image in the horizontal crop area is converted from 1920 × 1080 pixels to 1280 × 720 pixels. An image 521 in FIG. 5 is an image obtained by the resizing processing on the image of the horizontal crop area 520. When the size (both the vertical width and the horizontal width) corresponding to the component to be processed is larger than the size (before the resizing processing) of the horizontal crop area, the size of the horizontal crop area may not be converted or may be enlarged.

In S405, the microcomputer 108 determines whether or not to rotate the image in the vertical crop area. In the case of rotating, the process proceeds to S407. Otherwise, the process proceeds to S406. In the present embodiment, when the component to be processed is the network output unit 121, the microcomputer 108 determines not to rotate the image of the vertical crop area. The component that is always determined not to rotate the image of the vertical crop area may not be the network output unit 121. Furthermore, in the present embodiment, the microcomputer 108 can perform setting regarding rotation of the image of the vertical crop area (setting of whether or not to perform rotation, direction of rotation, magnitude of rotation, and the like) for the external output unit 118 and the external output unit 120. In the present embodiment, it is possible to perform setting to rotate 90 degrees to the right (rotate 270 degrees to the left), setting to rotate 270 degrees to the right (rotate 90 degrees to the left), and setting not to rotate. Therefore, in a case where the component to be processed is the external output unit 118 or the external output unit 120, the microcomputer 108 determines whether or not to rotate the image of the vertical crop area according to the state of the setting (rotation setting) related to rotation.

For example, the microcomputer 108 performs setting related to rotation in accordance with an instruction from a user. The instruction related to the rotation from the user may be performed using the operation switch group 109 or may be performed using an external device. The microcomputer 108 may automatically perform the setting related to the rotation based on the image of the vertical crop area, the display device to be used, the output unit to be used, or the like. The setting related to the rotation may be individually performed for each of the external output unit 118 and the external output unit 120.

In S406, the microcomputer 108 acquires the image of the vertical crop area from the main image, performs resizing processing on the acquired image, and controls the display resizing circuit 104 to store the image after the resizing processing in the RAM 111. Consider a case where the size of the main image is 3840 × 2160 pixels, the size corresponding to the component to be processed is 1280 × 720 pixels, and the size of the vertical crop area is 1080 × 1920 pixels. In this case, the size of the image of the vertical crop area is converted from 1080 × 1920 pixels to 405 × 720 pixels. An image 513 in FIG. 5 is an image obtained by the resizing processing on the image in the vertical crop area 510. When the size corresponding to the component to be processed is 720 × 1280 pixels, the size of the image of the vertical crop area may be converted from 1080 × 1920 pixels to 720 × 1280 pixels. When the size (both the vertical width and the horizontal width) corresponding to the component to be processed is larger than the size (before the resizing processing) of the vertical crop area, the size of the vertical crop area may not be converted or may be enlarged.

In S407, the microcomputer 108 controls the display resizing circuit 104 to acquire the image of the vertical crop area from the main image, perform the rotation processing on the acquired image, perform the resizing processing on the image after the rotation processing, and store the image after the resizing processing in the RAM 111. Consider a case where the size of the main image is 3840 × 2160 pixels, the size corresponding to the component to be processed is 1280 × 720 pixels, and the size of the vertical crop area is 1080 × 1920 pixels. In this case, the image of the vertical crop area is rotated by approximately 90 degrees or approximately 270 degrees with a direction perpendicular to the image of the vertical crop area as an axis, and the size of the image after the rotation is converted from 1920 pixels × 1080 to 1280 × 720 pixels. An image 511 in FIG. 5 is an image obtained by the resizing processing on the image after the rotation processing (after the rotation). When the size (both the vertical width and the horizontal width) corresponding to the component to be processed is larger than the size (before the resizing processing) of the vertical crop area after the rotation processing, the size of the vertical crop area after the rotation processing may not be converted or may be enlarged. The rotation processing may be performed after the resizing processing.

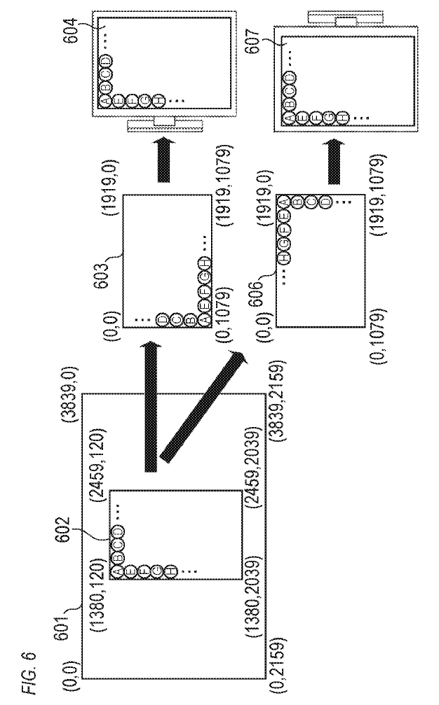

The rotation processing in S407 will be described with reference to FIG. 6. FIG. 6 illustrates each image and coordinates (horizontal position and vertical position) in each image. In FIG. 6, an image 601 is a main image, and an area 602 is a vertical crop area (before rotation). A to H are pixels in the vertical crop area 602.

An image 603 is obtained by rotating the image in the vertical crop area 602 to the left (counterclockwise) by 90 degrees (to the right (clockwise) by 270 degrees). The lower left corner of the image 603 after the rotation corresponds to the upper left corner of the vertical crop area 602 (before the rotation). Thus, when the orientation of the display device is the vertical orientation rotated to the right by 90 degrees (to the left by 270 degrees) from the normal position as in display 604, the image 603 (image in the vertical crop area 602) can be displayed on the entire display surface (most part of the display surface) in the correct orientation.

An image 606 is obtained by rotating the image in the vertical crop area 602 to the right by 90 degrees (to the left by 270 degrees). The upper right corner of the image 606 after the rotation corresponds to the upper left corner of the vertical crop area 602 (before the rotation). Thus, when the orientation of the display device is the vertical orientation rotated to the right by 270 degrees (to the left by 90 degrees) from the normal position as in display 607, the image 606 (image in the vertical crop area 602) can be displayed on the entire display surface (most part of the display surface) in the correct orientation.

In S408, the microcomputer 108 controls the OSD generation circuit 106 to generate an item indicating the direction and magnitude of the rotation of the image of the crop area based on the setting related to the rotation. Then, the microcomputer 108 controls each unit of the imaging device 100 so that the generated item is superimposed on the main image and displayed on the liquid crystal panel 107. That is, when the determination is YES in S405, the item indicating the direction and magnitude of the rotation is superimposed on the main image together with the crop frame generated in S400 and displayed on the liquid crystal panel 107. In the present embodiment, the item indicating the direction and magnitude of the rotation is an item (lower item) indicating a direction corresponding to the downward direction (predetermined direction) of the image of the crop area after the rotation. The downward direction, which is the predetermined direction, may be interpreted as the downward direction of the display device that displays the image of the crop area after the rotation. The predetermined direction may be a direction different from the downward direction. The item indicating the direction and magnitude of the rotation may be a combination of an arrow indicating the direction and a numerical value indicating the magnitude of the rotation.

In S409, the microcomputer 108 controls each unit of the imaging device 100 so as to output the image after the resizing processing generated in any one of S403, S404, S406, and S407 and stored in the RAM 111 to the component to be processed. The image after the resizing processing is output and displayed by the line sequential driving system. A plurality of lines of the images after the resizing processing are output line by line from the top to the bottom of the image.

For example, the microcomputer 108 may control the external output signal processing unit 117 to output the image after the resizing processing from the external output unit 118 to an external display device. Similarly, the microcomputer 108 may control the external output signal processing unit 119 to output the image after the resizing processing from the external output unit 120 to an external display device. The microcomputer 108 may control the compression/expansion circuit 114 to encode the image after the resizing processing and control the network output unit 121 to output the encoded image to an external network.

As described above, in the present embodiment, the microcomputer 108 controls each unit of the imaging device 100 so that the crop frame generated in S400 and the lower item generated in S408 are superimposed on the main image and displayed on the liquid crystal panel 107 (display control). In the present embodiment,

in the case of the vertical crop output, the partial image is output by rotating the partial image according to the setting related to rotation, and in the case of the horizontal crop output, the partial image is output without being rotated regardless of the setting related to rotation. In a case where the vertical crop area is set as the crop area and the setting related to rotation is a setting for performing rotation, the main image in which the crop frame and the lower item are superimposed is displayed on the liquid crystal panel 107. Then, in a case where the horizontal crop area is set, and in a case where the vertical clock area is set but the setting related to rotation is the setting not to perform rotation, the lower item is not displayed, and the main image on which the crop frame indicating the crop area is superimposed is displayed on the liquid crystal panel 107. Note that the method of making it possible to identify the crop area, the direction of rotation, the magnitude of rotation, and the like is not limited to the superimposition of items. For example, the pixel values of the main image may be changed so that they are identifiable. Furthermore, in a case where different crop areas are set for each component to be processed, the crop frame and the lower item may be generated in different colors or the like for each component to be processed.

As a result of the display processing of FIG. 4, display 503 is performed as display of the image 502 of FIG. 5, display 512 is performed as display of the image 511, display 514 is performed as display of the image 513, and display 522 is performed as display of the image 521.

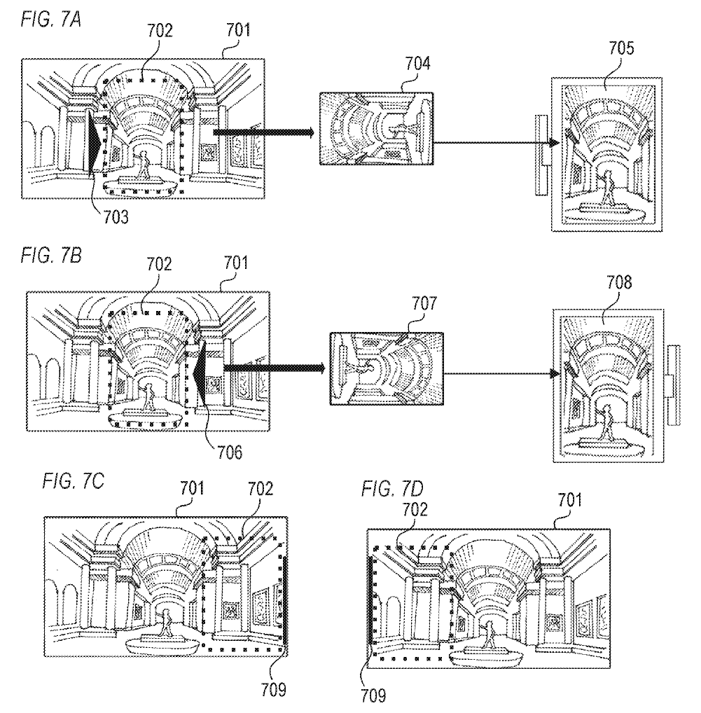

The crop frame generated in S400 and the lower item generated in S408 in FIG. 4 will be described with reference to FIGS. 7A to 7D. An image 701 in FIGS. 7A to 7D is a main image displayed on the liquid crystal panel 107, and a crop frame 702 indicates a vertical crop area.

An image 704 of FIG. 7A is obtained by rotating the image of the vertical crop area indicated by the crop frame 702 to the left by 90 degrees (rotating to the right by 270 degrees). The lower side of the image 704 corresponds to the left side of the crop frame 702. Therefore, in a case where the vertical crop output is set and rotation by 90 degrees to the left (rotation by 270 degrees to the right) is set, a lower item 703 to be superimposed on the left side of the crop frame 702 is generated in S408. Then, the lower item 703 is superimposed on the main image 701 (the left side of the crop frame 702) and displayed on the liquid crystal panel of the imaging device 100. By viewing the lower item 703 superimposed on the left side of the crop frame 702, the user can easily grasp that a preferred display 705 is realized by rotating the display device 90 degrees to the right from the normal position.

An image 707 in FIG. 7B is obtained by rotating the image in the vertical crop area indicated by the crop frame 702 to the right by 90 degrees (rotating to the left by 270 degrees). The lower side of the image 707 corresponds to the right side of the crop frame 702. Therefore, in a case where the vertical crop output is set and rotation by 90 degrees to the right (rotation to the left by 270 degrees) is set, a lower item 706 to be superimposed on the right side of the crop frame 702 is generated in S408. Then, the lower item 706 is superimposed on the main image (the right side of the crop frame 702) and displayed on the liquid crystal panel of the imaging device 100. By viewing the lower item 706 superimposed on the right side of the crop frame 702, the user can easily grasp that a preferred display 708 is realized by rotating the display device 90 degrees to the left from the normal position.

Note that, although an example of using a lower item having a triangular shape has been described, the shape of the lower item is not limited to the triangular shape. For example, as illustrated in FIGS. 7C and 7D, the lower item may be a linear item 709. The item indicated by the vertical crop area and the item indicating the direction and magnitude of the rotation may be the same common item. For example, as the crop frame indicating the vertical crop area, a crop frame may be generated in which a side that becomes a lower side by rotation is indicated by a solid line and the remaining sides are indicated by a broken line among a plurality of sides of the vertical crop area. As the crop frame indicating the vertical crop area, a crop frame may be generated in which a side that becomes a lower side by rotation and the remaining sides are indicated in different colors among a plurality of sides of the vertical crop area.

Also, the lower item may or may not always be displayed. By enabling the display of the lower item (an aspect in which the direction and magnitude of the rotation are identifiable) only when necessary, it is possible to suppress a decrease in visibility of the main image due to the lower item, and it is possible to improve convenience.

For example, in a case where the external output is set but the external output of the image (in the present embodiment, the image of the crop area after rotation) related to the lower item is not performed, the microcomputer 108 may not display the lower item on the liquid crystal panel 107. The microcomputer 108 may enable the display of the lower item (an aspect in which the direction and magnitude of the rotation are identifiable) at the start timing of the external output of the image related to the lower item. For the external output unit 118, 120 and the like, the start timing of the external output may be interpreted as the detection timing of the connection (HDMI connection) of the display device. The microcomputer 108 may disable the display of the lower item (an aspect in which the direction and magnitude of the rotation are identifiable) at a timing after a predetermined time from the start timing of the external output of the image related to the lower item.

In a case where the setting related to the rotation is not changed, the microcomputer 108 may not display the lower item. The microcomputer 108 may enable the display of the lower item (an aspect in which the direction and magnitude of the rotation are identifiable) at the timing when the setting related to the rotation is changed (timing at which rotation is enabled, timing at which the direction and magnitude of the rotation are changed, or the like). The microcomputer 108 may disable the display of the lower item (an aspect in which the direction and magnitude of the rotation are identifiable) at a timing a predetermined time after the timing at which the setting is changed.

In a case where the crop area (In the present embodiment, the vertical crop area to be rotated) related to the lower item is not set, the microcomputer 108 may not display the lower item. The microcomputer 108 may enable the display of the lower item (an aspect in which the direction and magnitude of the rotation are identifiable) at the timing when the crop area related to the lower item is set. The microcomputer 108 may disable the display of the lower item (an aspect in which the direction and magnitude of the rotation are identifiable) at a timing after a predetermined time from the timing at which the crop area related to the lower item is set. The timing at which the crop area is set may be interpreted as the timing at which the crop area is specified by the user.

Furthermore, the microcomputer 108 may make the display of the lower item (a mode in which the direction and magnitude of the rotation are identifiable) different depending on the position of the crop frame with respect to the main image. For example, in a case where the side of the crop frame corresponding to the lower side of the image after rotation is near the edge of the main image, the microcomputer 108 displays the linear lower item 709. In a case where there is a space capable of displaying the triangular lower item 703 between the side of the crop frame corresponding to the lower side of the image after the rotation and the end of the main image, the microcomputer 108 displays the triangular lower item 703.

The display of the lower item (an aspect in which the direction and magnitude of the rotation are identifiable) may be interpreted as an aspect in which the side of the vertical crop area in the direction corresponding to the downward direction (predetermined direction) of the image after rotation can be identified. The aspect in which the direction and magnitude of the rotation are identifiable may be made different depending on whether or not the end of the crop area on the side of the direction corresponding to the downward direction of the image after rotation is within the area of a predetermined distance from the end of the main image on the side of the direction corresponding to the downward direction of the image after the rotation.

Furthermore, the microcomputer 108 may make the display of the lower item (an aspect in which the direction and magnitude of the rotation are identifiable.) different depending on the output unit that outputs the image (in the present embodiment, the image of the crop area after rotation) related to the lower item. The output unit that outputs the image related to the lower item may be interpreted as a crop area (in the present embodiment, the vertical crop area to be rotated) related to the lower item. For example, the lower item may be displayed in red in the case of the external output unit 118, and the lower item may be displayed in green in the case of the external output unit 120. In this way, the user can easily grasp not only the preferred orientation of the display device but also which display device orientation should be changed (the orientation of the display device connected to which output unit should be changed), and the convenience can be improved.

In the above-described embodiment, an example in which the crop frame and the lower item are displayed on the liquid crystal panel 107 has been described. However, when the present image is displayed on an external display device, the crop frame and the lower item may be displayed on the external display device. The other display device is a display device connected to the external output unit 118, a display device connected to the external output unit 120, a display device connected to the network output unit 121 (via a network), or the like. The crop frame and the lower item may be displayed on all the display devices that display the entire main image, or may be displayed on some (specific) display devices that display the entire main image. For example, the entire main image may be displayed, and the crop frame and the lower item may be displayed on an external display device in which OSD display is ON. The orientation of the liquid crystal panel 107 with respect to the imaging device 100 (main body) may be changeable, and the image of the crop area may be displayed on the liquid crystal panel 107.

Furthermore, the display device connected to the external output unit 118, the display device connected to the external output unit 120, the display device connected to the network output unit 121 (via the network), and the like may be or may not be a display dedicated device. For example, the display device may be a controller or the like having a display function. The control signal from the controller may be received by the network output unit 121 (communication unit), a dedicated reception circuit, or the like. The control signal may be received by a consumer electronics control (CEC) function or the like defined in the HDMI standard.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, when a horizontally long display device is installed and used in a vertical orientation, a vertically long image can be suitably displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012024, filed January 28, 2025, which is hereby incorporated by reference herein in its entirety.

What is claimed is:

1. An imaging device comprising:
an image sensor;
an output interface configured to output an image to an outside;
a processor; and
a memory storing a program which, when executed by the processor, causes the imaging device to:
execute setting processing of setting a part of a captured image captured by the image sensor as a crop area;
execute display control processing of performing control to display the captured image on a display in an aspect in which the crop area is identifiable;
execute acquisition processing of acquiring a partial image, which is an image of the crop area, from the captured image;
execute rotation processing of rotating the partial image; and
execute control processing of performing control to rotate, by the rotation processing, the partial image acquired by the acquisition processing and output the partial image after the rotation from the output interface, wherein
in the display control processing, control is performed so as to display the captured image on the display in an aspect in which a direction and a magnitude of the rotation by the rotation processing are further identifiable.

2. The imaging device according to claim 1, wherein
the aspect in which the crop area is identifiable is an aspect in which an item indicating the crop area is superimposed on the captured image, and
the aspect in which the direction and magnitude of the rotation by the rotation processing are identifiable is an aspect in which an item indicating the direction and magnitude of the rotation by the rotation processing is superimposed on the captured image.

3. The imaging device according to claim 1, wherein the aspect in which the direction and magnitude of the rotation by the rotation processing are identifiable is an aspect in which a direction corresponding to a predetermined direction of the partial image after the rotation by the rotation processing is identifiable.

4. The imaging device according to claim 3, wherein the predetermined direction is a downward direction.

5. The imaging device according to claim 1, wherein in the display control processing, control is performed such that the aspect in which the direction and magnitude of the rotation by the rotation processing are identifiable is enabled at a start timing of external output by the output interface, and the aspect in which the direction and magnitude of the rotation by the rotation processing are identifiable is disabled at a timing after a predetermined time from the start timing.

6. The imaging device according to claim 1, wherein in the display control processing, control is performed such that the aspect in which the direction and magnitude of the rotation by the rotation processing are identifiable is enabled at a timing when the crop area is set by the setting processing, and the aspect in which the direction and magnitude of the rotation by the rotation processing are identifiable is disabled at a timing after a predetermined time from the timing when the crop area is set.

7. The imaging device according to claim 1, wherein
when the program is executed by the processor, the program further causes the imaging device to execute rotation setting processing of performing setting related to the rotation by the rotation processing, and
in the display control processing, control is performed such that the aspect in which the direction and magnitude of the rotation by the rotation processing are identifiable is enabled at a timing when a setting related to the rotation by the rotation processing is changed, and the aspect in which the direction and magnitude of the rotation by the rotation processing are identifiable is disabled at a timing after a predetermined time from the timing when the setting is changed.

8. The imaging device according to claim 7, wherein in the display control processing, at a timing when the setting related to the rotation by the rotation processing is changed so as not to perform the rotation by the rotation processing, control is not performed so as to enable the aspect in which the direction and magnitude of the rotation by the rotation processing are identifiable.

9. The imaging device according to claim 7, wherein in the rotation setting processing, the setting related to the rotation by the rotation processing is performed according to an instruction from a user.

10. The imaging device according to claim 1, wherein
when the program is executed by the processor, the program further causes the imaging device to execute rotation setting processing of performing setting related to the direction and magnitude of the rotation by the rotation processing, and
in the rotation setting processing, as the direction and magnitude of the rotation by the rotation processing, at least setting of rotating by 90 degrees in a predetermined direction and setting of rotating by 270 degrees in the predetermined direction are performable.

11. The imaging device according to claim 10, wherein
in the display control processing, control is performed such that a first item indicating the crop area is displayed for the aspect in which the crop area is identifiable, and a second item indicating a direction corresponding to a predetermined direction of the partial image after rotation by the rotation processing is displayed for the aspect in which the direction and magnitude of the rotation by the rotation processing are identifiable, and
in the display control processing, in a case where the crop area is a vertical crop area having a vertical length larger than a horizontal length, control is performed to display the second item according to the setting by the rotation setting processing, and in a case where the crop area is a horizontal crop area having a horizontal length larger than a vertical length, control is performed not to display the second item regardless of the setting by the rotation setting processing.

12. The imaging device according to claim 11, wherein in the control processing, in a case where the crop area is the vertical crop area, control is performed to rotate the partial image by the rotation processing and output the partial image from the output interface according to the setting by the rotation setting processing, and in a case where the crop area is the horizontal crop area, control is performed to output the partial image from the output interface without rotating the partial image regardless of the setting by the rotation setting processing.

13. The imaging device according to claim 1, wherein in the setting processing, an area specified by a user is set as the crop area.

14. The imaging device according to claim 1, wherein
the aspect in which the direction and magnitude of the rotation by the rotation processing are identifiable is an aspect in which a side of the crop area in a direction corresponding to a predetermined direction of the partial image after rotation by the rotation processing is identifiable, and
in the display control processing, the aspect in which the direction and magnitude of the rotation by the rotation processing are identifiable is different depending on whether or not an end of the crop area on the side in the direction corresponding to the predetermined direction of the partial image after the rotation by the rotation processing exists within an area of a predetermined distance from an end of the captured image on the side in the direction corresponding to the predetermined direction of the partial image after the rotation by the rotation processing.

15. The imaging device according to claim 1, further comprising a second output interface configured to output an image to the outside, wherein
in the control processing, in a case where the partial image is output from the second output interface, control is performed so as to output the partial image without being rotated by the rotation processing.

16. The imaging device according to claim 15, wherein the second output interface outputs the image to an external network.

17. The imaging device according to claim 1, comprising a plurality of output interfaces for outputting an image to the outside, wherein
in the setting processing, the crop area corresponding to any one of the plurality of output interfaces is set, and
in the display control processing, the aspect in which the direction and magnitude of the rotation by the rotation processing are identifiable is different depending on an output interface corresponding to the crop area.

18. A control method of an imaging device, comprising:
setting a part of a captured image captured by the imaging device as a crop area;
performing control to display the captured image on a display in an aspect in which the crop area is identifiable;
acquiring a partial image, which is an image of the crop area, from the captured image;
executing rotation processing of rotating the partial image; and
performing control to rotate the acquired partial image by the rotation processing and output the partial image after the rotation from an output interface to an outside, wherein
control is performed so as to display the captured image on the display in an aspect in which a direction and a magnitude of the rotation by the rotation processing are further identifiable.

19. A non-transitory computer readable medium that stores a program, wherein the program causes a computer to execute a control method of an imaging device, comprising:
setting a part of a captured image captured by the imaging device as a crop area;
performing control to display the captured image on a display in an aspect in which the crop area is identifiable;
acquiring a partial image, which is an image of the crop area, from the captured image;
executing rotation processing of rotating the partial image; and
performing control to rotate the acquired partial image by the rotation processing and output the partial image after the rotation from an output interface to an outside, wherein
control is performed so as to display the captured image on the display in an aspect in which a direction and a magnitude of the rotation by the rotation processing are further identifiable.
